(19) United States
(12) Patent Application Publication
(10) Pub. No.: US 2008/0291678 A1
(43) Pub. Date: Nov. 27, 2008

(54) Illumination Unit for Satellite Dish

(76) Inventor: Tom P. Vincent, Breman, OH (US)

Correspondence Address: JERRY SEMER, 617 CROGHAN ST., FREMONT, OH, 43420, US

(21) Appl. No.: 11/658,287

(22) PCT Filed: Jul. 28, 2005
(86) PCT No.: PCT/US2005/026889

§ 371 Date: Jan. 23, 2007

Related U.S. Application Data
(60) Provisional application No. 60/598,140, filed on Jul. 31, 2004.

(51) Int. Cl. F21V 33/00

(52) U.S. Cl. 362/253

(57) ABSTRACT

The invention is a light (24) that illuminates a satellite dish (14). It attaches to the arm (11) of the receiver cone (15). The power for the light comes from the power going from the power supply of the satellite dish. The light (24) in the preferred embodiment is a LED or an array of LEDs.

### FIELD OF INVENTION

This invention relates to the field of illumination units for a satellite dishes and more particularly to an LED illumination unit that runs off the power supplied by the satellite dish receiver.

### BACKGROUND OF THE INVENTION

The invention is an illumination unit for a satellite dish. The illumination unit allows an individual to place a light upon his satellite dish at night. The light of course is helpful in protecting the satellite dish from vandalism and also allows an individual to view the satellite dish for damage during a storm at night. It also allows the individual to make his satellite dish more than just an eyesore in the backyard. He can cover the satellite dish with his favorite sports team or his college or high school colors. The light allows the luminous covering to be shown at night.

A person purchasing the light can easily hook up the light to the satellite dish. The light is designed to only come on at night and has a photo electric circuit that determines day and night and turns the light on at night. In the preferred embodiment, the light is a set of an array of LED's or just an LED that produces a precise beam that shines upon the satellite dish.

### SUMMARY OF THE INVENTION

The invention is a light that illuminates a satellite dish. It attaches to the arm of the receiver cone. The power for the light comes from the power going to the power supply of the satellite dish. In one embodiment, the light has a photo cell and a detection circuit that enables the light to only come on at night. The light in the preferred embodiment is a LED or an array of LEDs that allows the light to be highly precise and intense. The light is designed to be easily hooked up to a satellite dish. It attaches to the arm of the receiver cone of the satellite dish. The light is designed so that once attached, it will shine directly upon the satellite dish. Further, the light power comes from the power supply to the satellite dish.

### BRIEF DESCRIPTION OF THE DRAWINGS

FIG. 1 is a perspective view of a satellite dish with the invention attached.

FIG. 2 is a top view of the light unit.

FIG. 3 is a side view of the light unit.

FIG. 3A is a sectional view along line A-A of FIG. 1.

FIG. 4A is a view of the electrical schematic for the electrical circuit of the light unit for one embodiment with one LED.

FIG. 4B is a view of the electrical schematic for the electrical circuit of the light unit for another embodiment with two LEDs.

FIG. 4C is a view of the electrical schematic for the electrical circuit of the light unit for another embodiment with three LEDs.

FIG. 4A is a view of the electrical schematic for the electrical circuit of the light unit with a photo cell.

FIG. 5 is a side view of another embodiment of the invention.

### DETAILED DESCRIPTION OF THE PREFERRED EMBODIMENT

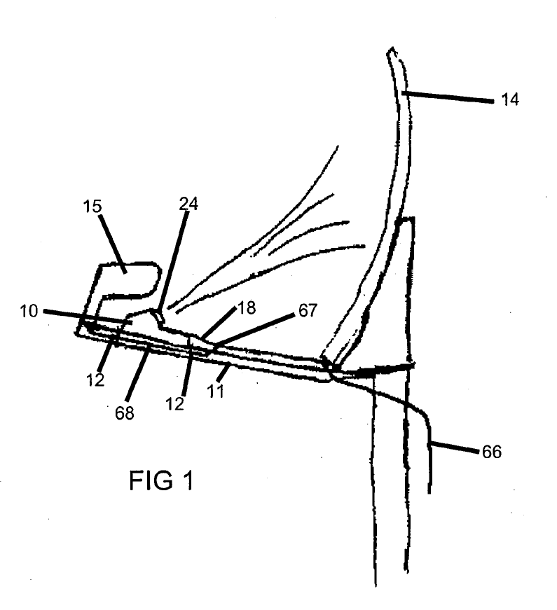

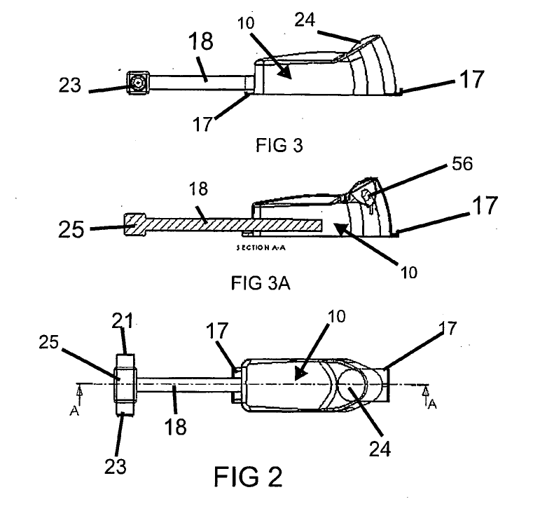

FIG. 1 shows the light attached to the satellite dish. FIG. 1 shows the light unit 10 attached to the receiver cone arm 11 of the receiver cone 15 of the satellite dish 14. The light unit 10 attaches to the receiver cone arm 11 by two straps 12 shown in FIG. 2 that encircle the receiver cone arm 11. In the preferred embodiment the two straps 12 are zip tabs. In the preferred embodiment, the light unit 10, when attached properly to the receiver cone arm 11, will direct the light upon the satellite dish 14. The light unit 12 has two flaps 17 shown in FIG. 2 on witch the two straps 12 are placed. The light 24, when the light unit 10 is attached properly to the receiver cone arm 11, makes a 30 degree angle with that receiver cone arm 11 as shown in FIG. 3 and thus, shines directly upon the satellite dish 14. Running from the light unit 10 is a cable 18. The splicer 25 opposite the end attached to the light unit 10 of cable 18 is attached to the cable 66 going to the home. Cable 68 runs from the splicer 25 to the receiver cone 15. Cables 68 and 66 carry the signal from the receiving cone to the home. They also carry the power from the home to the receiving cone. Cable 18 is spliced into cables 68 and 66 so that some of the power from the home is diverted to the lamp.

FIG. 2 shows a top view of light unit 10. FIG. 2 shows that a cable 18 is attached to light unit 10. This cable 18 brings the power to run light unit 10 from the cable 68 from the home. Cable 68 is attached to one end either 21 or 23 of cable splicer 25. FIG. 2 also shows the light 24. In the preferred embodiment the light 24 is an LED or an array of LEDs. LEDs were chosen since they are highly efficient, use little power and shine a precise narrow beam on the satellite dish 14. Attached to both ends of light unit 10 are tabs 17. These tabs 17 a strap 12 is placed over to attach the light unit to the receiver cone arm 11.

FIG. 3 is a side view of the invention. FIG. 3 shows the light unit 10 attached to one end of cable 18. Attached to the other end of cable 18 is the cable splicer 25. FIG. 3A shows a section view of the light unit 10 with cable 18 along line A-A of FIG. 1. FIG. 3A shows the led 56 that lies behind lens 19 of light 24.

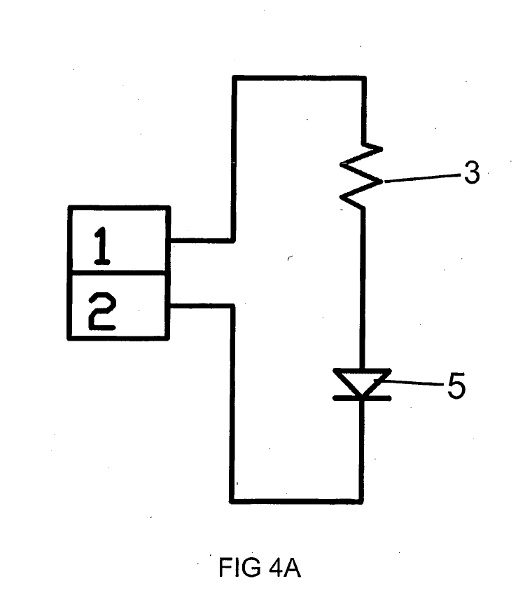

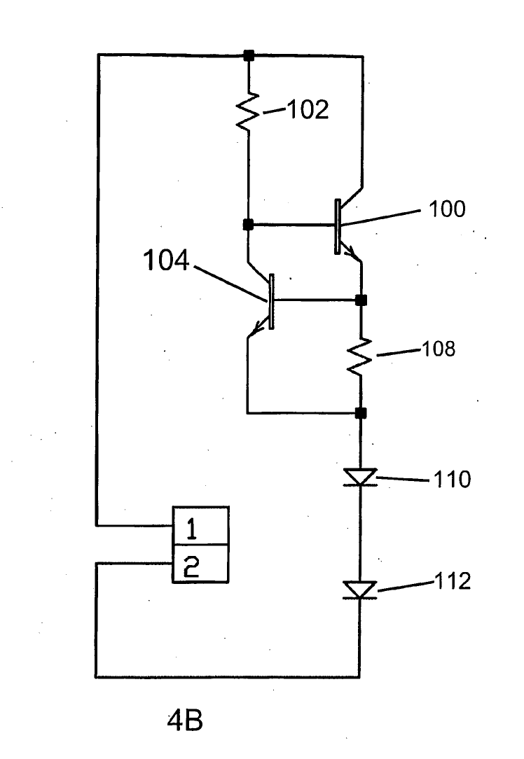

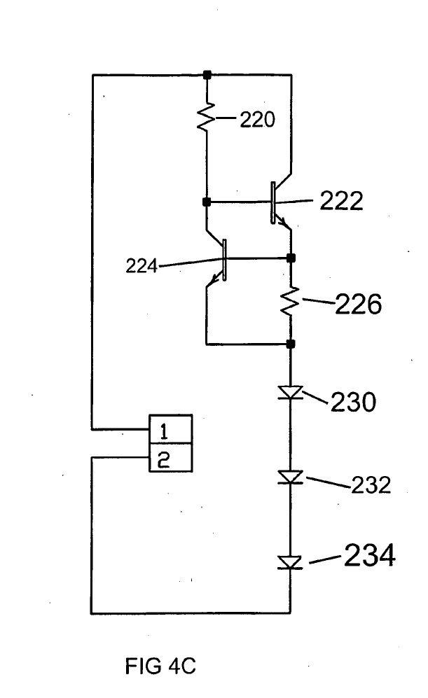

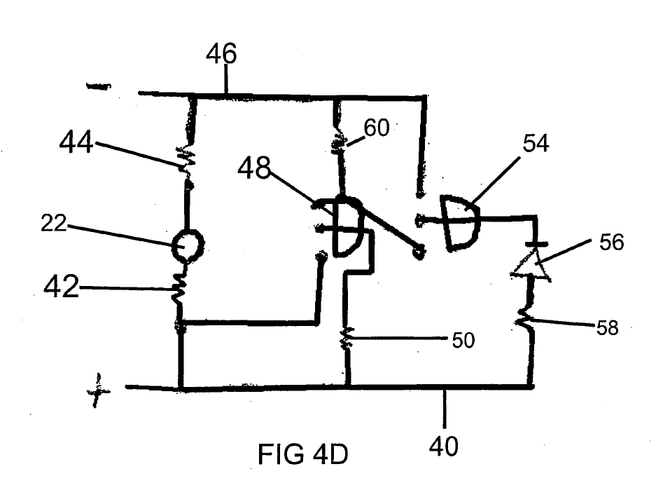

FIG. 4A shows the schematic of the circuit within light unit 10. Lines 1 and 2 are attached to cable 18. The power from the home comes in from line 18 and runs through resistor 3. Resistor 3 is a 560 ohm half watt resistor. The power then continues to the LED 5. The circuit is completed by attaching to the output line in cable 18. This embodiment shown in FIG. 4A has only one LED. Another embodiment with 2 LEDs is shown in FIG. 4B. Here again the input and output lines running from cable 18 are 1 and 2. The power runs from input line 1 coming from the house through cable 18 into the source of transistor 100 and into the base of transistor 100 through resistor 102. Resistor 102 is an 8,450 ohm resistor. Transistor 100 is a 2N2222 transistor. The collector of transistor 100 is attached to the base of a second transistor 104 which is also a 2N2222 transistor. The source of transistor 204 is attached to the base of transistor 100 and resistor 102. The base of transistor 104 is also attached to resistor 108 which is a 30 ohm resistor. The other end of resistor 108 is attached to the collector of transistor 104 and LED 110. LED 110 is attached to the second LED 112. LED 112 is then attached to the output line of cable 18 to complete the circuit.

A third embodiment which has three LED's is shown in FIG. 4C. In FIG. 4C the input and output lines are again 1 and 2 from cable 18. The power runs in from cable 18 through resistor 220 which is a 560 ohm resistor. The power is also attached to the source of transistor 222. Transistor 222 is a 2N2222. The other end of resistor 220 is attached to the base of transistor 222. The base of transistor 222 is also attached to the source of transistor 224. Transistor 224 is a 2N2222. The base of transistor 224 is attached to the collector of transistor 222. The base of transistor 224 is also attached to one end of resistor 226. Resistor 226 is a 30.1 ohm resistor. The collector of transistor 224 is attached to the other end of resistor 226. Resistor 226 is then attached to three LEDs 230, 232, and 234 in series. The LEDs are then attached in series to the output to cable 18.

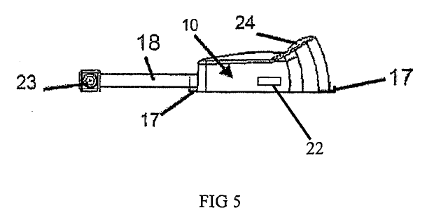

FIG. 4 D is a schematic for another embodiment of the invention. In this embodiment the light is off during the day and shines at night. In this embodiment a photo electric cell 22 shown in FIG. 5 turn the LED 56 on at night. FIG. 4 shows the photo electric cell 22 is attached to two transistors 48 and 54 that enable the photo electric cell 22 to turn on when it determines it is night. As shown in the schematic, the LED 56 runs on 3.5 volts at 20 milliamps. The incoming power form the power supply is 5 volts. This incoming power comes from cable 66 from the home through cable 18 to the light unit 10. The schematic shows the photo electric cell 22 is hooked up across the incoming power with a 56 k ohms resistor 42 on the positive side 40 and a 470 ohms resistor 44 on the negative side 46. Before the resistor 42 a transistor 48 is attached. The center lead of the transistor 48 runs to the positive side 40 of the incoming power through a 3 k ohms resistor 50. The third lead of the transistor 48 is attached through a 47 k ohm resistor 60 to the negative side 46 of the incoming power. The third lead of the transistor 48 is also attached to a lead of transistor 54. The third lead of transistor 54 is attached to the negative side 46 of the incoming power. The center lead of transistor 54 is attached to the LED 56 at one end. The other end of the LED 56 is attached to the positive side 40 of the incoming power through a 20 ohm resistor 58.

FIG. 5 shows another embodiment of the invention. FIG. 5 differs from FIG. 3 in that FIG. 5 shows the photo electric cell 22 attached to the side of the light unit 10.

Changes and modifications in the specifically described embodiments can be carried out without departing from the scope of the invention which is intended to be limited only by the scope of the appending claims.

I claim:

1. A light unit that illuminates a satellite dish comprising:
a. a light; and,
b. a means of attaching the light to a satellite dish and said light is designed such that when the light is attached to the satellite dish, the light will directs a light beam onto the front of the satellite dish; and,
c. a means for powering the light that is attached to the light.

2. A light unit that illuminates a satellite dish as in claim 1 wherein:
a. the light is a LED.

3. A light unit that illuminates a satellite dish as in claim 1 wherein:
a. the light is two or more LEDs.

4. A light unit that illuminates a satellite dish as in claim 1 wherein:
a. the means for powering the light is by diverting some of the power from the power supply of the satellite dish to the light.

5. A light unit that illuminates a satellite dish as in claim 1 further comprising:
a. a means for turning off and on the light that turns the light on at night and off during the day.

6. A light unit that illuminates a satellite dish as in claim 4 wherein:
a. the means for turning off and on the light turns the light on at night and off during the day is a photo electric cell and circuitry that determines it is daytime and turns off the light or nighttime and turns on the light.

7. A light unit that illuminates a satellite dish at night comprising:
a. a light; and,
b. a means of attaching the light to a satellite dish and said light is designed such that when the light is attached to the satellite dish, the light directs a light beam onto the front of the satellite dish; and,
c. a means for powering the light that is attached to the light; and,
e. a means for turning the light off during the day.

8. A light unit that illuminate a satellite dish at night as in claim 7 wherein:
a. a means for turning the light off during the day is a photo electric cell and circuitry that determines it is daytime.

9. A light unit that illuminate a satellite dish as in claim 1 wherein:
a. said satellite dish has a receiver cone arm, and
b. said light is attached to the receiver cone arm.

10. A light unit that illuminate a satellite dish as in claim 9 wherein:
a. the means of attaching the light to a satellite dish is a strap that attaches the light unit to the receiver cone arm.

11. A light unit that illuminate a satellite dish as in claim 10 wherein:
a. the light is a LED.

12. A light unit that illuminate a satellite dish as in claim 11 wherein:
a. the means for powering the light is by diverting some of the power from the power supply of the satellite dish to the light.

13. A light unit that illuminates a satellite dish as in claim 1 further comprising:
b. a means for turning off and on the light that turns the light on at night and off during the day.

14. A light unit that illuminate a satellite dish as in claim 13 wherein:
a. the means for turning off and on the light turns the light on at night and off during the day is a photo electric cell and circuitry that determines it is daytime and turns off the light or nighttime and turns on the light.

15. A light unit that illuminate a satellite dish as in claim 9 wherein:
a. the light is attached to the receiver cone arm at an angle such that a light beam from the light is directed at the front of the satellite dish.
